(19) United States
(12) Patent Application Publication
(10) Pub. No.: US 2023/0179486 A1
(43) Pub. Date: Jun. 8, 2023

(54) METHOD AND APPARATUS RELATED TO NETWORK ANALYSIS

(71) Applicant: Industrial Technology Research Institute, Hsinchu (TW)

(72) Inventors: Ming-Gu Yang, Hsinchu City (TW); Te-Yen Liu, Taoyuan City (TW); Chien-Hung Wu, Kaohsiung City (TW)

(73) Assignee: Industrial Technology Research Institute, Hsinchu (TW)

(21) Appl. No.: 17/574,580

(22) Filed: Jan. 13, 2022

(30) Foreign Application Priority Data
Dec. 8, 2021 (TW) 110145766

(51) Int. Cl. H04L 41/12; H04L 41/147

(52) U.S. Cl. CPC H04L 41/12; H04L 41/147

(57) ABSTRACT

A method and an apparatus related to network analysis are provided. A work topology is mapping into an abstract topology according to a workload's network behavior. The network behavior is defined by a connection of the workload via one or more ingress ports and/or one or more egress target ports. The work topology records one or more ingress ports or one or more egress target ports supported by the workload. The abstract topology records a dynamic relationship of the currently operating ingress port or egress target port of the workload and a corresponding anomaly rule. The dynamic relationship is compared with the anomaly rule to determine that an abnormal situation occurs on the workload. The abnormal situation is related to a violation of the workload model which comprises static role, dynamic relationship, and the anomaly rule. The dynamic relationship is an associated behavior between the workload and another workload via the ingress ports and/or the egress target ports of the workload.

### CROSS-REFERENCE TO RELATED APPLICATION

This application claims the priority benefit of Taiwan application serial no. 110145766, filed on Dec. 8, 2021. The entirety of the above-mentioned patent application is hereby incorporated by reference herein and made a part of this specification.

### TECHNICAL FIELD

The disclosure relates to an information security technology, particularly to a method and an apparatus related to network analysis.

### BACKGROUND

Cybersecurity has become a major industry in today's computing landscape. According to the statistics from the Ministry of Economic Affairs, the scale of information security industry in Taiwan was NT$55.2 billion in 2020, at a growth rate of 11.9%, which is higher than the world's growth rate of 2.8%, and the output value of the information security industry is estimated to reach NT$78 billion by 2025. With the rapid increase in the number of distributed applications in data centers, applications are advanced to virtual machine applications and microservice applications that run in containers. And their network behavior changes even more, presenting information security systems greater challenges. Therefore, it has become an urgent issue for system administrators to detect malicious behaviors spreading laterally on the intranet and to implement security isolation effectively.

The whitelist of network behaviors is a mechanism for detecting and isolating malicious behaviors, and its purpose is to regulate the system resources and the communication protocol scope that the subject matter accesses legally. With the whitelist mechanism, all items except the subject matter are not allowed to be accessed legally. Traditionally, system administrators maintain the whitelists manually, which works for a small data center or a small-scale distributed application system to operate normally. However, when the number of servers increases, manual maintenance tends to lead to erroneous management, and may even cause system abnormal operation by making minor rule changes.

### SUMMARY

In view of this, embodiments of the present disclosure provide a method and an apparatus related to network analysis.

The network analysis method of the embodiment of the disclosure includes (but is not limited to) the following steps. A work topology is mapped into an abstract topology according to the network behavior of the workload. The network behavior is defined by the connection of the workload via one or more ingress ports and/or one or more egress target ports. The work topology records one or more ingress ports or one or more egress target ports supported by the workload, and the abstract topology records the dynamic relationship of the ingress port or the egress target port of the workload that is currently operating and a corresponding anomaly rule. The workload connections with workload model which comprises static role, dynamic relationship, and the anomaly rule are compared to determine that an abnormal situation occurs on the workload. The abnormal situation is related to the violation of the anomaly rule, and the dynamic relationship is an associated behavior specification between the workload and another workload via the ingress port or the egress target port of the workload.

The analysis apparatus of the embodiment of the disclosure includes (but is not limited to) a memory and a processor. The memory is configured to store a program code, and the processor is coupled to the memory. The processor is configured to load and execute the program code to map a work topology into an abstract topology according to the network behavior of the workload, and compare the dynamic relationship with the anomaly rule to determine that an abnormal situation occurs on the workload. The network behavior is defined by the connection of the workload via one or more ingress ports and/or one or more egress target ports. The work topology records one or more ingress ports or one or more egress target ports supported by the workload, and the abstract topology records the static role, and the dynamic relationship of the ingress port or the egress target port of the workload that is currently operating and the corresponding anomaly rule. The abnormal situation is related to the violation of the anomaly rule, and the dynamic relationship is an associated behavior between the workload and another workload via the ingress port or the egress target port of the workload.

To make the features of the disclosure more comprehensible, the following embodiments are described in detail with drawings to as follows.

### BRIEF DESCRIPTION OF THE DRAWINGS

FIG. 1 is a block diagram of a system according to an embodiment of the disclosure.

FIG. 2 is a flowchart of a network analysis method according to an embodiment of the disclosure.

FIG. 3 is a schematic diagram of an ordinary topology according to an embodiment of the disclosure.

FIG. 4 is a schematic diagram of a work topology converted from the ordinary topology in FIG. 3 according to an embodiment of the disclosure.

FIG. 5 is a schematic diagram of different roles in a static relationship according to an embodiment of the disclosure.

FIG. 6 is a schematic diagram of target roles and intermediate roles according to an embodiment of the disclosure.

FIG. 7 is a schematic diagram of an abstract topology mapped from the work topology in FIG. 4 according to an embodiment of the disclosure.

FIG. 8 is a schematic diagram of a finite-state machine according to an embodiment of the disclosure.

FIG. 9A is a schematic diagram of an abstract behavior model according to an embodiment of the disclosure.

FIG. 9B is a schematic diagram of an abstract behavior model according to another embodiment of the disclosure.

FIG. 9C is a schematic diagram of an abstract behavior model according to still another embodiment of the disclosure.

FIG. 10A is a schematic diagram of the legal situation of a work topology and an abstract topology according to an embodiment of the disclosure.

FIG. 10B is a schematic diagram of the abnormal situation of a work topology and an abstract topology according to an embodiment of the disclosure.

FIG. 11 is a flowchart of troubleshooting according to an embodiment of the disclosure.

FIG. 12 is a flowchart of behavior analysis according to an embodiment of the disclosure.

### DETAILED DESCRIPTION

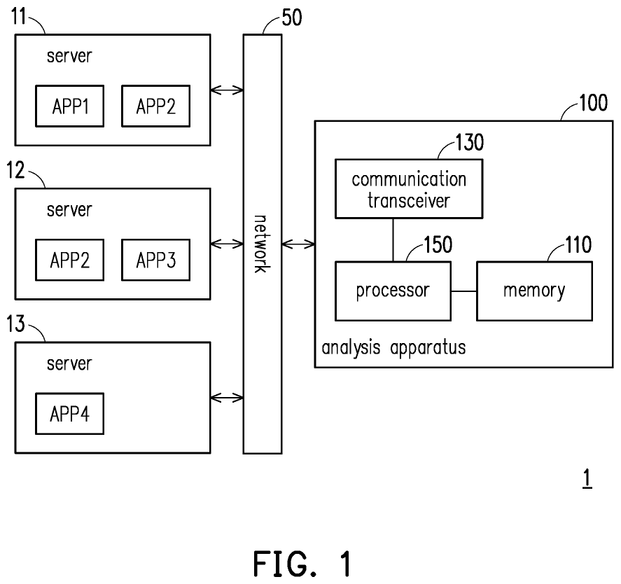

FIG. 1 is a block diagram of a system 1 according to an embodiment of the disclosure. In FIG. 1, the system 1 includes (but is not limited to) servers 11, 12, and 13 and an analysis apparatus 100. It should be noted that the quantity of each device shown in the figure is only an example, and the user can adjust it based on their actual needs.

The servers 11, 12, and 13 may be any type of computer system, server, or mobile device. The servers 11, 12, and 13 respectively run application programs APP1 to APP4. In an embodiment, one or more of the application programs APP1 to APP4 is a work machine, a virtual machine, or a containerized application program. In another embodiment, one or more of the application programs APP1 to APP4 are applications or services directly run by a host system.

The analysis apparatus 100 may be any type of computer system, server, or mobile device. The analysis apparatus 100 includes (but is not limited to) a memory 110 and a processor 150.

The memory 110 may be any type of fixed or removable random access memory (RAM), read-only memory (ROM), flash memory, Hard Disk Drive (HDD), solid-state drive (SSD), or similar components. In an embodiment, the memory 110 is configured to record program codes, software modules, configurations, data (for example, topology, rules, models, etc.) or files, and the embodiments will be described in detail later.

The processor 150 is coupled to the memory 110, and the processor 150 may be a central processing unit (CPU), a graphics processing unit (GPU), other programmable general-purpose or special-purpose microprocessor, digital signal processor (DSP), programmable controller, field programmable gate array (FPGA), application-specific integrated circuit (ASIC), neural network accelerator, other similar components, or a combination thereof. In one embodiment, the processor 150 is configured to perform all or part of the operations of the analysis apparatus 100 and can load and execute various program codes, software modules, files, and data in the memory 110. In one embodiment, the functions of the processor 150 may be implemented by software or a chip. In some embodiments, multiple functions of the processor 150 may be respectively implemented by the same or different processing elements.

In an embodiment, the analysis apparatus 100 further includes a communication transceiver 130. The communication transceiver may be a transceiver circuit that supports wired networks such as optical fiber, Ethernet, or TV cables, or wireless networks such as Wi-Fi, mobile networks, and Bluetooth. In an embodiment, the communication transceiver 130 includes components such as (but not limited to) digital-to-analog converters, amplifiers, antennas, mixers, etc., depending on its type. In one embodiment, the processor 150 communicates with the servers 11, 12, and 13 via the communication transceiver 130 and the network 50 (for example, a local area network, the Internet, or a private network) to receive data from the servers 11, 12, and 13 or send data to the servers 11, 12, and 13 accordingly.

In some embodiments, at least one of the servers 11, 12, and 13 may be integrated with the analysis apparatus 100 into an independent apparatus, so that the analysis apparatus 100 runs one or more of the application programs APP1 to APP4.

Hereinafter, various components and modules in the system 1 are used to illustrate the method according to the embodiments of the disclosure. Each process of the method may be adjusted accordingly based on different implementations, to which the disclosure is not limited.

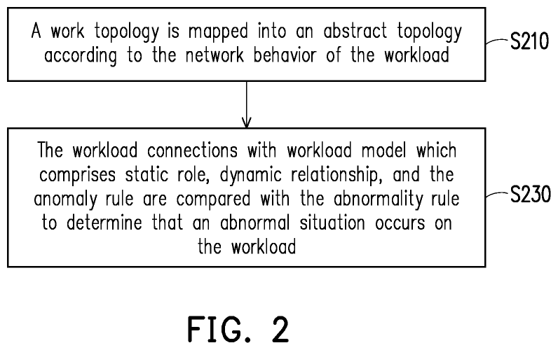

FIG. 2 is a flowchart of a network analysis method according to an embodiment of the disclosure. In FIG. 2, a processor 150 maps a work topology into an abstract topology according to the network behavior of the workload (step S210). Specifically, any workload represents an application program (for example, application programs APP1 to APP4) run by the servers 11, 12, and 13. In one embodiment, the network behavior is defined by the connection of the workload via one or more ingress ports and/or one or more egress target ports. For example, if the application APP1 is a web browser and is connected to the web server executed by the application APP4, the application APP1 may use port 80.

Note that any communication endpoint of a computer network may be regarded as a port. Port is a logical concept and is configured to identify or distinguish types or procedures of network services. With this in mind, if an application establishes a connection, the connection is associated with one or more ports.

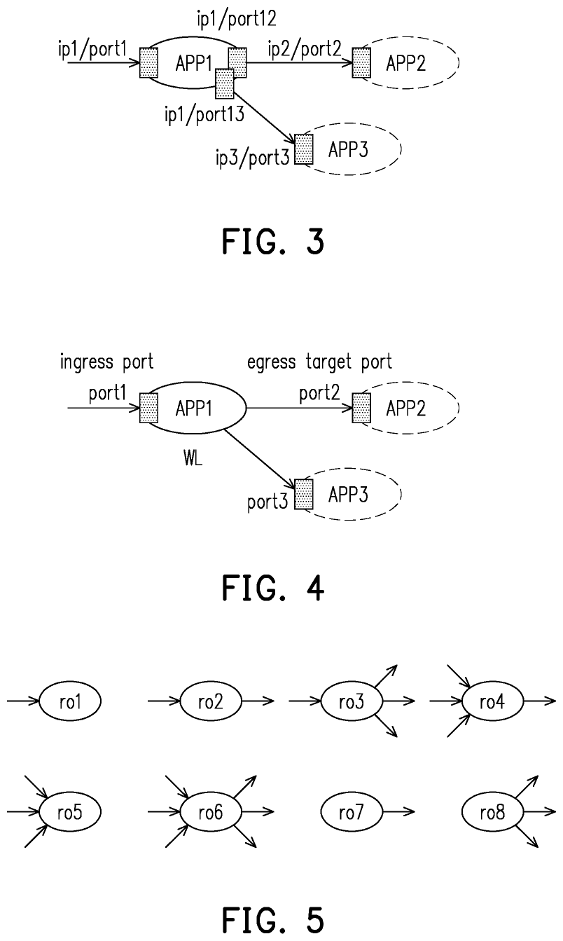

Ports may be divided into a source port and a destination port, each representing the request-initiating endpoint and the request-receiving endpoint of a certain network service. For example, FIG. 3 is a schematic diagram of an ordinary topology according to an embodiment of the disclosure. In FIG. 3, when the application APP1 uses a network service to establish a connection with the application APP2, the source port is port port12 and the destination port is port2. In one embodiment, an ingress port represents a destination port provided by an application program for other applications to connect to. For example, in FIG. 3, it is assumed that the network service provided by the application APP1 is connected to and used by other applications through port port1. In one embodiment, the egress target port represents the ingress port of the application provided to connect to other applications. For example, in FIG. 3, it is assumed that the network service provided by the application APP2 is used by the application APP1 via port port2.

In one embodiment, ports are further associated with a network address (for example, an Internet Protocol (IP) address). For example, in FIG. 3, the application APP1 is configured with a network address ip1, the application APP2 is configured with a network address ip2, and the application APP3 is configured with a network address ip3. In other words, any application can connect to the application APP1 by setting the destination address as the network address ip1 and the destination port as port port1, and so on. The same description will not be repeated hereinafter.

In one embodiment, the application program is further defined with an application (app) name. However, the app name may still be optionally chosen based on their actual needs.

In an embodiment, the processor 150 converts the ordinary topology into a work topology. An ordinary topology (or called a network topology) describes the arrangement/connection of network nodes and their connections in a communication network. As shown in FIG. 3, the ordinary topology records the app names of network nodes (APP1 to APP3 in this embodiment) and the source ports or the destination ports supported or used by them (for example, ports port1, port12, port13, port2, and port3). The processor 150 reserves the app name (optionally), the ingress port, and the egress target port. In one embodiment, the processor 150 can delete the network address and the source port in the ordinary topology.

For example, FIG. 4 is a schematic diagram of a work topology converted from the ordinary topology of FIG. 3 according to an embodiment of the disclosure. In FIG. 3 and FIG. 4, for the application APP1, the app name (for example, “first APP”), the ingress port (for example, port1), and the egress target ports (for example, ports port2, and port3) of this workload WL are reserved. However, the network address ip1 of the application APP1 and the ports port12 and port13 as the source ports recorded in the ordinary topology of FIG. 3 are discarded.

In another embodiment, the processor 150 may use the ordinary topology directly as the work topology, and obtain part of the information, for example, app name, ingress port, and/or egress target port, in the ordinary topology based on subsequent analysis needs.

On the other hand, the abstract topology records the dynamic relationship of the ingress port or the egress target port of the workload that is currently operating and the corresponding anomaly rules. Similarly, the abstract topology is also classified according to network behavior, and each category regulates its network behavior with ingress port, egress target port, and app name.

Note that, unlike work topology, abstract topology replaces any network node with one of the abstract behavior models. In one embodiment, the network behavior specifications of each abstract behavior model include static relationships. That is, abstract topology records more of the static relationships. The static relationship regulates the number of connections between ingresses and egresses of a single workload and may be divided into multiple roles. This connection relationship is the corresponding relationship between the number of ingress ports provided by a single workload and the number of egress target ports used.

For example, FIG. 5 is a schematic diagram of different roles in a static relationship according to an embodiment of the disclosure. In FIG. 5, the role ro1 represents a one-to-zero connection, meaning that the workload only provides one ingress port. The role ro2 represents a one-to-one connection, meaning that the workload only provides one ingress port and uses one egress target port. The role ro3 represents a one-to-many connection relationship, meaning that the workload provides one ingress port and uses multiple egress target ports (for example, the number of egress target ports is more than 1). The role ro4 represents a many-to-one connection relationship, meaning that the workload provides multiple ingress ports (for example, the number of ingress ports is more than 1) and only uses one egress target port. The rest may be deduced by analogy. The role ro5 represents a many-to-zero connection, role ro6 represents a many-to-many connection, role ro7 represents a zero-to-one connection, and role rob represents a zero-to-many connection.

In one embodiment, roles may be divided into target roles and intermediate roles. The target role refers to the ultimate role of the workload during runtime, and the intermediate role refers to the transition role at one point during runtime. The processor 150 may determine the target role of the workload based on the defined model, and one or more intermediate roles corresponding to the target role are the legal role scope of the workload in the evolution process of the abstract topology. The processor 150 may determine the target role of the workload based on one or more intermediate roles during runtime. The number of ingress ports and the egress target ports of the target role are respectively the sum of the number of ingress ports and the sum of the number of egress target ports of the intermediate role at one or more points during runtime. These points may be the points that are updated due to new connections or new workloads during the topology evolution process, or they may be points that are different from another point by a specific time period.

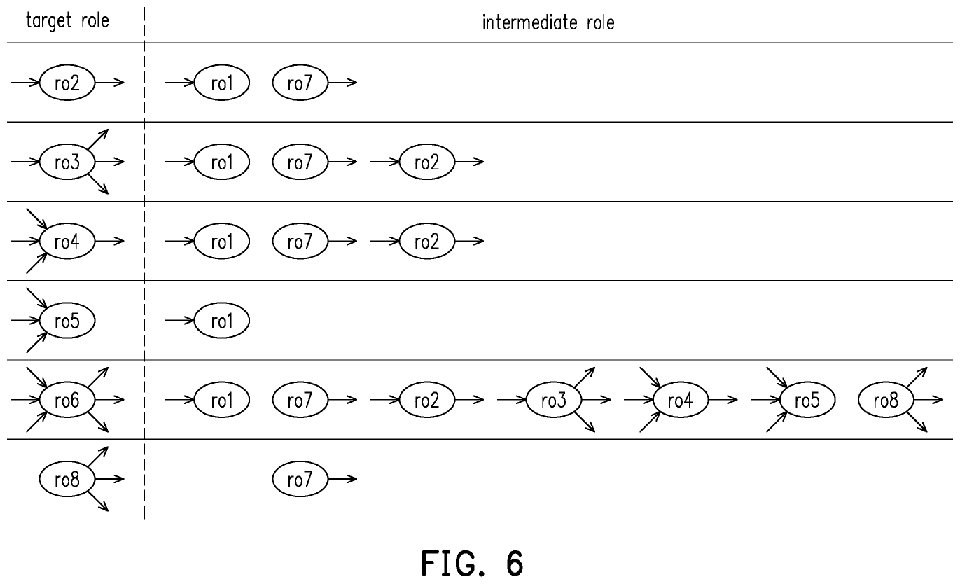

For example, FIG. 6 is a schematic diagram of target roles and intermediate roles according to an embodiment of the disclosure. In FIG. 6, during runtime, the intermediate role includes the role ro1 (i.e., one-to-zero) and the role ro7 (i.e., zero-to-one), and the target role is the role ro2 (i.e., one-to-one). During runtime, the intermediate roles include the role ro1 (i.e., one-to-zero), the role ro7 (i.e., zero-to-one), and the role ro2 (i.e., one-to-one). Assuming that the ingress port used by the role ro1 is the same as the role ro2 but the egress destination port used by the role ro7 is different from the role ro2, the target role is the role ro3 (i.e., one-to-many). During runtime, the intermediate roles include the role ro1 (i.e., one-to-zero), the role ro7 (i.e., zero-to-one), and the role ro2 (i.e., one-to-one). Assuming that the ingress port used by the role ro1 is different from the role ro2 but the egress destination port used by the role ro7 is the same as the role ro2, the target role is the role ro4 (i.e., many-to-one). During runtime, the intermediate roles include the role ro1 (i.e., one-to-zero). Assuming that the ingress ports used by the role ro1 at two points are different, the target role is the role ro5 (i.e., many-to-zero). During runtime, intermediate roles include role ro1 (i.e., one-to-zero), role ro7 (i.e., zero-to-one), role ro2 (i.e., one-to-one), role ro3 (i.e., one-to-many), role ro4 (i.e., many-to-one), role ro5 (i.e., many-to-zero), and role ro8 (i.e., zero-to-many). Assuming that the ingress port used by the role ro1 is different from the role ro2 and the egress destination port used by the role ro7 is different from the role ro4, the target role is the role ro6 (i.e., many-to-many). During runtime, the intermediate role includes the role ro7 (i.e., zero-to-one). Assuming that the role ro7 at the three points uses different egress destination ports, the target role is the role ro8 (i.e., zero-to-many).

In one embodiment, the network behavior specifications of each abstract behavior model include dynamic relationships. That is, the abstract topology records the dynamic relationship of the ingress port or the egress target port where the workload is currently running. The dynamic relationship is the associated behavior between a workload and another workload via an ingress port or an egress target port of the workload. For example, in FIG. 4, for the application APP1, when the ingress port is port1, the egress target is application APP2 and port2; when the ingress port is port1, the egress target is the application APP2 and the port port2 or (that is, the OR logic) application APP3 and the port port3; or, when the ingress port is the port port1, the egress targets are application APP2 and port2, and (that is, the AND logic) the application APP3 and the port port3.

In one embodiment, the network behavior specifications of each abstract behavior model include anomaly rules (or called logic condition restrictions), that is, the anomaly rules corresponding to the workload in a specific static relationship and/or dynamic relationship recorded by the abstract topology. Anomaly rules describe the conditions corresponding to normal connections.

In one embodiment, the abnormality rule includes a limit on the number of normal connections. In one embodiment, the number of connections is defined as a specific number, an upper limit, or a lower limit. The specific number is a hard condition that must be met for normal connections; for example, the number of normal connections can only be three. The upper limit is the uppermost limit of the conditions that must be met for normal connections; for example, the number of normal connections is at most five. The lower limit of quantity is the lowest limit of the conditions that must be met for normal connections. For example, the number of normal connections is at least one.

It should be noted that, in other embodiments, the anomaly rule may also be restriction for app names or specific ports. For example, it can only be connected to the application APP2. For another example, at least the port port1 needs to be provided as an ingress port.

In an embodiment, the processor 150 determines that the network behavior of the workload belongs to one of a plurality of abstract behavior models. The processor 150 may establish one or more abstract behavior models, and each abstract behavior model is defined with corresponding static relationships, dynamic relationships, and anomaly rules. For example, the static relationship of the first model conforms to the role ro3, the dynamic relationship provides the application with a specific ingress port and/or the egress target port for connecting to other applications, and the anomaly rule is at least one connection. The processor 150 may adopt an abstract behavior model corresponding to the current network behavior of the workload to replace the network node in the work topology. After the network nodes in the work topology are replaced by the corresponding abstract behavior model, an abstract topology is formed. That is to say, the abstract behavior model is a specific specification (such as dynamic relationship, static relationship, or anomaly rules) to describe the network behavior of the workload and its restriction. In some embodiments, these abstract behavior models may be stored in a model database and be accessed by the processor 150 or other devices.

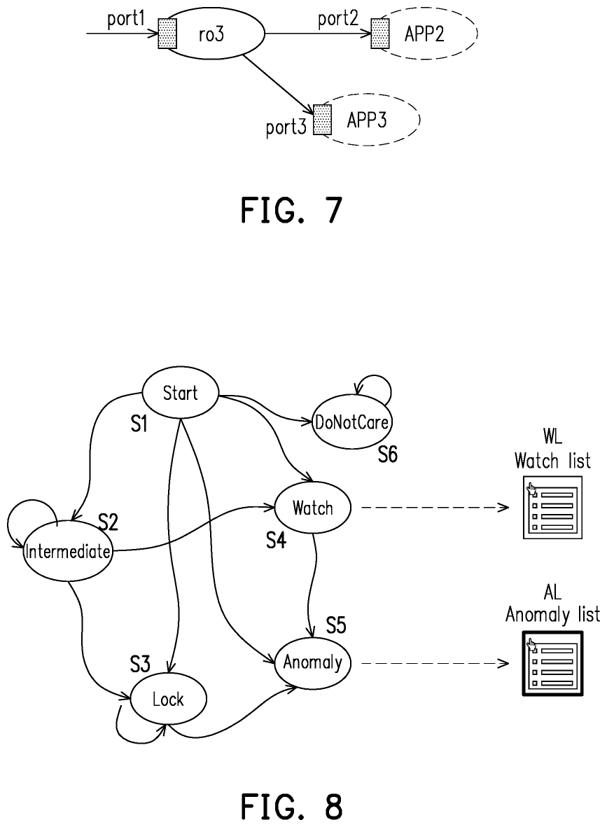

For example, FIG. 7 is a schematic diagram of the abstract topology mapped from the work topology in FIG. 4 according to an embodiment of the disclosure. Please refer to both FIG. 4 and FIG. 7. The static relationship of the application APP1 in FIG. 4 is the one-to-many role ro3. The dynamic relationship provides the port port1 as the ingress port for the application APP1, and the egress target of the application APP1 is the port port2 of the application APP2 or the port port3 of the application APP3. The upper limit of the number of the anomaly rule is 2.

In FIG. 2, the processor 150 compares the dynamic relationship with the abnormality rule to determine that an abnormal situation occurs on the workload (step S230). Specifically, abnormal situations are related to the violation of the anomaly rules. For example, the workload violates the corresponding anomaly rule under a specific static relationship and/or dynamic relationship.

In one embodiment, the anomaly rule is a limit on the number of connections. The processor 150 may compare whether the dynamic relationship of the workload at the current point in time meets the limit on the number of connections. For example, the limit on the number of connections is a specific number, which is 2. If the comparison result is that the number of the egress targets in the dynamic relationship of the workload is 2, then the condition set for the number of connections is met, and there is no abnormal situation; but if the comparison result is that the number of egress targets in the dynamic relationship is 3, the condition set for the number of connections is violated, and an abnormal situation occurs.

In one embodiment, the number of connections is defined as a specific number, an upper limit, or a lower limit. In response to the dynamic relationship meeting the specific number of connections, the processor 150 sets the workload to a first lock state. In response to the dynamic relationship meeting the upper limit of the number of abnormal connections, the processor 150 sets the workload to a second lock state. And in response to the dynamic relationship not meeting the lower limit of the number of abnormal connections, the processor 150 sets the workload to a third lock state. These three lock states may be the same or different from one another.

In one embodiment, in response to the workload being locked, the processor 150 continues to review the topology of the subsequent evolution of the workload. In response to the new dynamic relationship violating the anomaly rule, the processor 150 determines that the workload in the lock state has an abnormal situation. The topology of subsequent evolution refers to the work topology or the abstract topology updated by the subsequent newly added connections and/or workloads.

For example, if the workload in the lock state still does not satisfy the “specific number” (that is, not meeting the anomaly rule), then the processor 150 regards the network behavior of the workload as illegal or function error connection, and adds the workload to the anomaly list. If the workload in the lock state still violates the “upper limit,” the processor 150 regards the network behavior of the workload as illegal or function error connection, and adds the workload to the anomaly list. If the workload in the lock state still violates the “lower limit,” the processor 150 regards the network behavior of the workload as a function error connection, and adds the workload to a watch list. That is to say, the subsequent handling (for example, troubleshooting operation) of the abnormal situations may vary depending on different lock states.

In other embodiments, as long as the dynamic relationship of the workload does not meet the anomaly rule for the first time, the processor 150 may directly determine that an abnormal situation has occurred and ignore the lock state.

In an embodiment, the processor 150 may judge the state evolution of the workload during the runtime based on a finite-state machine, and the finite-state machine includes multiple states. For example, FIG. 7 is a schematic diagram of a finite-state machine according to an embodiment of the disclosure. In FIG. 7, those states may be divided into different states like Start state S1, Intermediate state S2, Lock state S3, Watch state S4, Anomaly state S5, and DoNotCare state S6. The state starts from the start state and evolves thereon according to the finite-state machine. The Intermediate state S2 refers to the process state of the intermediate role evolving to the target role.

If the workload is in the start state, it may evolve into the Intermediate state S2, the Lock state S3, the Watch state S4, the Anomaly state S5, or the DoNotCare state S6. If the workload is in the Intermediate state S2, it may evolve into the Lock state S3 or the Watch state S4. If the workload is in the Lock state S3, it may only evolve into the Anomaly state S5 or remain in the lock state (indicating that the workload remains in the normal state).

If the workload is in the Watch state S4, the processor 150 adds the workload to the watch list WL. If the workload is in the Anomaly state S5, the processor 150 adds the workload to an anomaly list AL, and considers that an abnormal situation has occurred. If the workload is in the Intermediate state S2, the Lock state S3, or the DoNotCare state S6, the processor 150 regards the workload as normal operation.

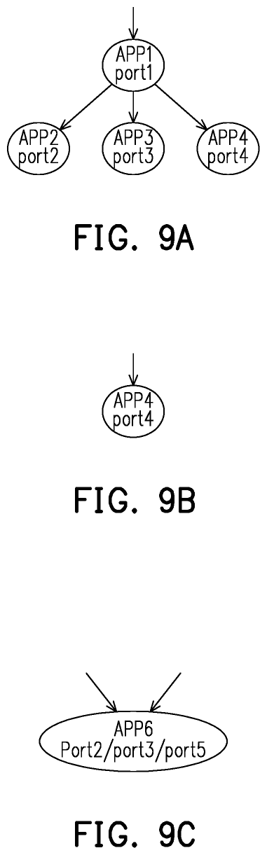

The following is an application scenario as an example for further description. FIG. 9A is a schematic diagram of an abstract behavior model according to an embodiment of the disclosure. In FIG. 9A, the first model is defined as follows (taking the application APP1 as an example, but it is not limited thereto): the static relationship conforms to the role ro3; the dynamic relationship provides the port port1 as the ingress port for the application APP1, the egress target of the application APP1 is the port port2 of the application APP2, the port port3 of the application APP3, or the port port4 of the application APP4; and the upper limit of the number of connections in the anomaly rule is 3. In other words, under the model, any application is allowed to connect to the port port1 and out to the port port2 of the application APP2, the port port3 of the application APP 3, or the port port4of the application APP 4, and the upper limit of connection is 3.

FIG. 9B is a schematic diagram of an abstract behavior model according to another embodiment of the disclosure. In FIG. 9B, the second model is defined as follows (taking the application APP4 as an example, but it is not limited thereto): the static relationship conforms to the role ro1; the dynamic relationship provides the port port4 as the ingress port for the application APP4, and the application APP4 has no egress target; the specific number of connections in the anomaly rule is 1. In other words, under the model, only the application APP1 is allowed to connect to the port port4, and the number of connections is defined as only one.

FIG. 9C is a schematic diagram of an abstract behavior model according to still another embodiment of the disclosure. In FIG. 9C, the third model is defined as follows (taking the application APP6 as an example, but it is not limited thereto): the static relationship conforms to the role ro5; the dynamic relationship provides the ports port5, port3, or port2 as the ingress ports for the application APP6, and the application APP6 has no egress target; the lower limit of the number of connections in the anomaly rule is 3. In other words, under the restriction of the anomaly rule, any application is allowed to connect to the ports port5, port3, or port2, and the lower limit of connection is 3.

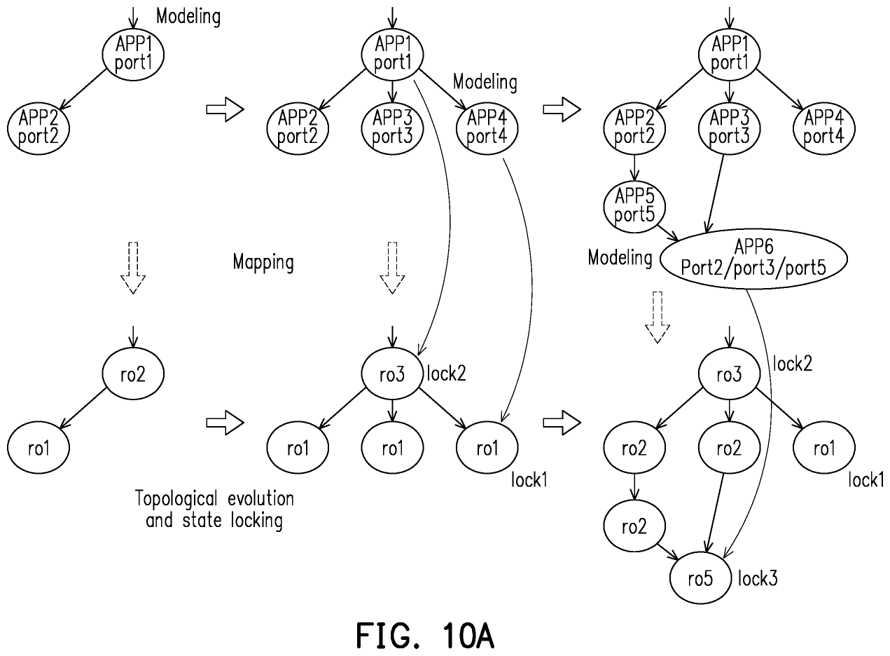

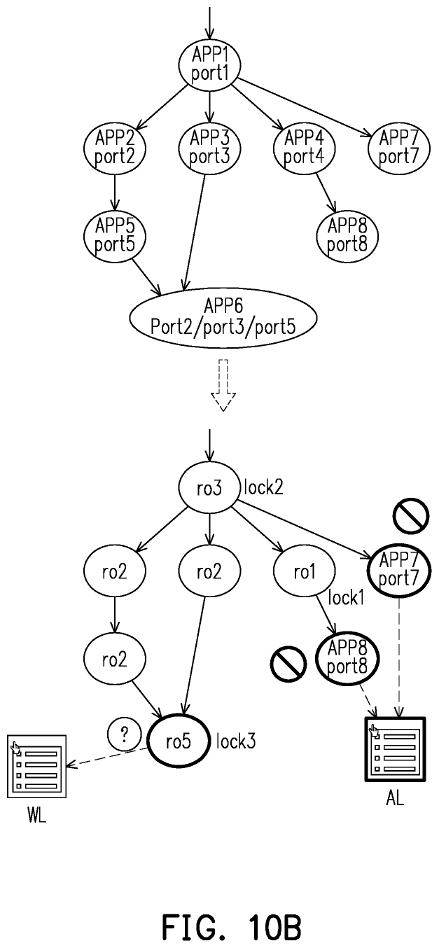

FIG. 10A is a schematic diagram of the legal situation of a work topology and an abstract topology according to an embodiment of the disclosure. The upper part of FIG. 10A is the evolution process of the work topology, and the lower part is the evolution process of the abstract topology mapped from the work topology. The middle part of the diagram shows how the application APP1 is modeled into the first model in FIG. 9A (its target role is the role ro3). Note that the application APP1 evolved from the role ro2 as the intermediate role to the role ro3 as the target role. If the application APP satisfies the rule of the upper limit, the processor 150 sets the workload to be in the second lock state lock2. In addition, the application APP4 is modeled into the second model of FIG. 9B (its target role is the role ro1). If the application APP4 evolves to the role ro1 as the target role and satisfies the rule of the specific number, the processor 150 sets the workload to be in the first lock state lock1.

Then, with the new applications APPS, APP6, and their connections join, the application APP1 stays to meet the upper limit of the number of connections in the anomaly rule again, so the application APP1 remains in the second lock state lock2. In addition, the application APP4 stays to meet the specific number of connections in the anomaly rule again, so the application APP4 remains in the first lock state lock1.

Note that the application APP6 is modeled into the third model of FIG. 9C (its target role is the role ro5). Assuming that the workload does not meet the lower limit of the number of connections in the anomaly rule for the first time, the processor 150 sets the workload to be in the third lock state lock3. Since the three workloads (on which the applications APP1, APP4, and APP6 are running respectively) have entered the lock state, for now the network behavior is in a legal situation.

FIG. 10B is a schematic diagram of a work topology and an abstract topology in the abnormal situation according to an embodiment of the disclosure. In FIG. 10B, assuming that FIG. 10A is further evolved into the work topology shown in the upper part of FIG. 10B. The newly added application APP7 adds an egress target (i.e., application APP7 and port 7) to the workload of application APP1, which makes the number exceeds the upper limit (for example, 3) set by the first model in FIG. 9A. Since the application APP1 is already in the second lock state lock2, the processor 150 may add related connection information (for example, the applications APP1 and APP7 and the port port7) to the anomaly list AL.

The newly added application APP8 adds an egress target (i.e., application APP8 and port8) to the workload of application APP4, which makes the number exceeds the specific number (for example, 1) set by the second model in FIG. 9B. Since the application APP4 is already in the first lock state lock1, the processor 150 may add related connection information (for example, the applications APP4 and APP8 and the port port8) to the anomaly list AL.

In addition, the application APP6 still does not meet the lower limit of the number of connections in the anomaly rule. Since the application APP6 is already in the third lock state lock3, the processor 150 may add the application APP6 and its port port6 to the watch list WL.

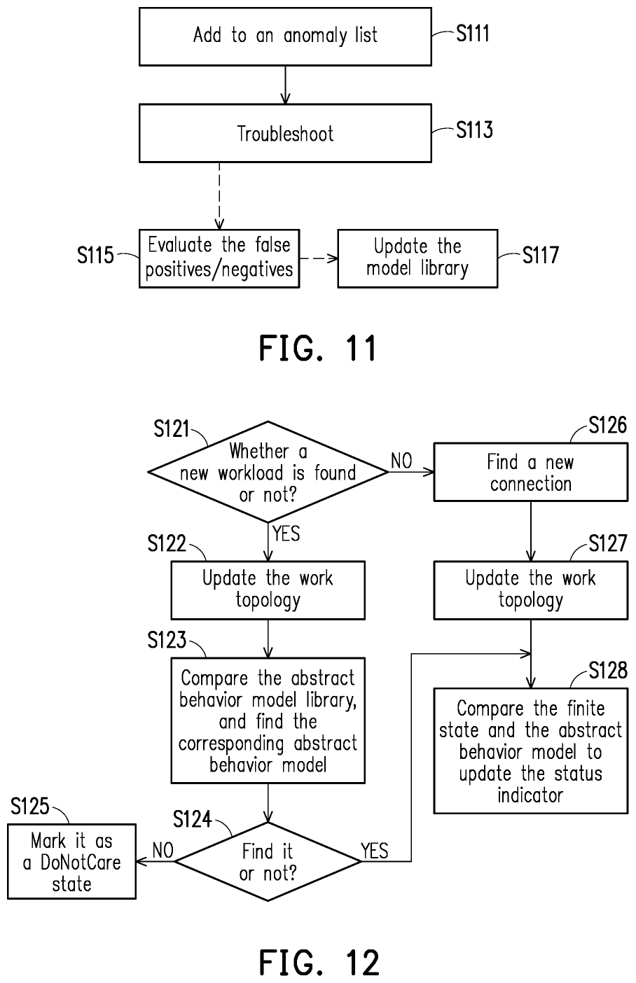

FIG. 11 is a flowchart of troubleshooting according to an embodiment of the disclosure. In FIG. 11, a processor 150 may add the workload in which the abnormality occurs to an anomaly list (step S111) and perform the troubleshooting operation according to the anomaly list (step S113). For example, the processor 150 warns the application or its host, and/or implements a corresponding whitelist firewall to block/interrupt network behaviors. The processor 150 may further evaluate the false positives/negatives of the normal situation and/or the abnormal situation (step S115), for example, by comparing detection results with actual results. In addition, the processor 150 may further update the model library (step S117) to improve accuracy. For example, if the detection result does not match the actual result, the processor 150 then updates or optimizes the specific abstract behavior model and firewall rules in the model library. The operating environment will immediately reflect the improvement effect of anomaly identification and detection, thereby reducing false results continuously.

The following is the description of the behavior analysis of step 5230. FIG. 12 is a flowchart of behavior analysis according to an embodiment of the disclosure. In FIG. 12, a processor 150 determines whether a new workload is found (step S121). If there is a new workload in the network 50, the processor 150 updates the work topology (step S122). The processor 150 compares the abstract behavior model library according to the updated work topology, and tries to find the corresponding abstract behavior model (step S123). The processor 150 confirms whether an abstract behavior model corresponding to the new workload is found (step S124). If the corresponding abstract behavior model is not found, the processor 150 marks/sets the new workload as a DoNotCare state S6 (step S125). If a corresponding abstract behavior model is found, the processor 150 compares the finite-state machine with the found abstract behavior model to update the status indicator of the new workload or other workloads connected to it (step S128).

On the other hand, there is no new workload in the network 50, and when the processor 150 finds a new connection in the network 50 (step S126), the processor 150 updates the work topology (step S127). Next, the processor 150 compares the finite state and the found abstract behavior model to update the status indicator of the workloads at both ends of the new connection (step S128).

In summary, in the apparatus and the method related to network analysis in the embodiments of the disclosure, whether an abnormal situation occurs is determined by describing the network behavior with relationships like static and dynamic relationships and then determining whether it meets or violates the anomaly rules of the abstract behavior model. In response to abnormal situations, the troubleshooting operation is further provided. In this way, a systematic method and a lightweight comparison operation are provided to fully describe network behaviors using a small number of parameters, continuously optimize and reduce spurious security incidents, and may adapt to data centers with different architectures and different distributed applications.

Although the disclosure has been disclosed in the above embodiments, they are not meant to limit the disclosure. Anyone with common, general knowledge in the art can make changes and modifications without departing from the spirit and scope of the disclosure. The scope of the disclosure shall be determined by the scope of the claims attached.

1. A network analysis method, comprising:
updating a work topology in response to detecting a new workload or a new connection from a workload;
mapping the work topology into an abstract topology according to a network behavior of the workload, wherein the network behavior is defined by at least one connection of the workload via at least one of at least one ingress port and at least one egress target port, the work topology records the at least one ingress port or the at least one egress target port supported by the workload, and the abstract topology records a dynamic relationship of one of the at least one ingress port or one of the at least one egress target port of the workload that is currently operating and a corresponding anomaly rule; and
comparing the at least one connection of the workload with a workload model which comprises a static role, a dynamic relationship, and the anomaly rule to determine that an abnormal situation occurs on the workload, wherein the abnormal situation is related to a violation of the anomaly rule, and the dynamic relationship is an associated behavior specification between the workload and another workload via one of the at least one ingress port or the at least one egress target port of the workload and is updated in response to the new workload or the new connection.

2. The network analysis method according to claim 1, whereas the anomaly rule comprises a connection number limit, and comparing the dynamic relationship with the anomaly rule comprises:
comparing whether the dynamic relationship meets the connection number limit. on the number of connections.

3. The network analysis method according to claim 2, wherein the connection number limit comprises of a specific number, an upper limit, and a lower limit, and comparing whether the dynamic relationship meets the connection number limit on the number of connections comprises:
in response to the dynamic relationship meeting the specific number, setting the workload to a first lock state;
in response to the dynamic relationship meeting the upper limit of the number, setting the workload to a second lock state; and
in response to the dynamic relationship not meeting the lower limit of the number, setting the workload to a third lock state.

4. The network analysis method according to claim 1, wherein comparing the dynamic relationship with the anomaly rule comprises:
in response to the workload in a lock state, continuously reviewing a subsequent evolution of the workload; and
in response to a new dynamic relationship violating the anomaly rule, determining that the abnormal situation occurs on the workload in the lock state.

5. The network analysis method according to claim 1, wherein the abstract topology further records a static relationship, the static relationship regulates a number of connections between ingresses and egresses and is divided into a plurality of roles, and the network analysis method further comprises:
determining a target role of the workload, wherein at least one intermediate role corresponding to the target role is a legal role scope in an evolution process of the abstract topology.

6. The network analysis method according to claim 1, wherein determining that the abnormal situation occurs on the workload comprises:
judging a state evolution of the workload during runtime based on a finite-state machine, wherein the finite-state machine comprises a plurality of states.

7. The network analysis method according to claim 1, wherein mapping the work topology into the abstract topology comprises:
determining that the network behavior of the workload belongs to one of a plurality of abstract behavior models, wherein each of the abstract behavior models is defined with corresponding static relationships, dynamic relationships, and anomaly rules, and the static relationships regulate a number of connections between ingresses and egresses.

8. The network analysis method according to claim 1, further comprising:
converting an ordinary topology into the work topology,
wherein a network address and a source port in the ordinary topology are discarded.

9. (canceled)

10. The network analysis method according to claim 1, wherein the workload is a work machine or a containerized application.

11. An analysis apparatus, comprising:
a memory, configured to store a program code; and
a processor, coupled to the memory, and configured to load and execute the program code to:
update a work topology in response to detecting a new workload or a new connection from a workload;
map the work topology into an abstract topology according to a network behavior of the workload, wherein the network behavior is defined by at least one connection of the workload via at least one of at least one ingress port and at least one egress target port, the work topology records the at least one ingress port or the at least one egress target port supported by the workload, and the abstract topology records a static role, and a dynamic relationship of one of the at least one ingress port or one of the at least one egress target port of the workload that is currently operating and a corresponding anomaly rule; and
compare the dynamic relationship with the anomaly rule to determine that an abnormal situation occurs on the at least one connection of the workload, wherein the abnormal situation is related to a violation of the anomaly rule, and the dynamic relationship is an associated behavior between the workload and another workload via one of the at least one ingress port or the at least one egress target port of the workload and is updated in response to the new workload or the new connection.

12. The analysis apparatus according to claim 11, whereas the anomaly rule comprises a connection number limit, and the processor is further configured to:
compare whether the dynamic relationship meets the connection number limit.

13. The analysis apparatus according to claim 12, wherein the connection number limit comprises a specific number, an upper limit, and a lower limit, and the processor is further configured to:
in response to the dynamic relationship meets the specific number, set the workload to a first lock state;
in response to the dynamic relationship meeting the upper limit of the number, set the workload to a second lock state; and
in response to the dynamic relationship not meeting the lower limit of the number, set the workload to a third lock state.

14. The analysis apparatus according to claim 11, wherein the processor is further configured to:
in response to the workload in a lock state, continuously review a subsequent evolution of the workload; and
in response to a new dynamic relationship violating the anomaly rule, determine that the abnormal situation occurs on the workload in the lock state.

15. The analysis apparatus according to claim 11, wherein the abstract topology further records a static relationship, the static relationship regulates a number of connections between ingresses and egresses and is divided into a plurality of roles, and the processor is further configured to:
determine a target role of the workload, wherein at least one intermediate role corresponding to the target role is a legal role scope in an evolution process of the abstract topology.

16. The analysis apparatus according to claim 11, wherein the processor is further configured to:
judge a state evolution of the workload during runtime based on a finite-state machine, wherein the finite-state machine comprises a plurality of states.

17. The analysis apparatus according to claim 11, wherein the processor is further configured to:
determine that the network behavior of the workload belongs to one of a plurality of abstract behavior models, wherein each of the abstract behavior models is defined with corresponding static relationships, dynamic relationships, and anomaly rules, and the static relationships regulate a number of connections between ingresses and egresses.

18. The analysis apparatus according to claim 11, wherein the processor is further configured to:
convert an ordinary topology into the work topology,
wherein a network address and a source port in the ordinary topology are discarded.

19. (canceled)

20. The analysis apparatus according to claim 11, wherein the workload is a work machine or a containerized application.
